(19) United States
(12) Patent Application Publication
(10) Pub. No.: US 2018/0266621 A1
(43) Pub. Date: Sep. 20, 2018

(54) DUAL-ARM GIMBAL

(71) Applicant: AUTEL ROBOTICS CO., LTD., Shenzhen (CN)

(72) Inventors: Zhengli ZHANG, Shenzhen (CN); Fazhan CHEN, Shenzhen (CN)

(21) Appl. No.: 15/977,323

(22) Filed: May 11, 2018

Related U.S. Application Data
(63) Continuation of application No. PCT/CN2016/102899, filed on Oct. 21, 2016.

(30) Foreign Application Priority Data
Nov. 20, 2015 (CN) 201520931071.3

(51) Int. Cl. F16M 11/12; F16M 13/02; F16M 11/10; F16M 11/20

(52) U.S. Cl. CPC F16M 11/12; F16M 11/2014; F16M 11/10; F16M 13/02

(57) ABSTRACT

The present application provides a dual-arm gimbal, including a support base, two support arms and two mounting bases. The support base is assembled on a gimbal base and a first motor is assembled in the support base; the two support arms are assembled on the support base and an upper end of each support arm is integrally connected to a first motor rotor of the first motor in the support base, so as to drive the support arm to rotate around the support base; and the two mounting bases are respectively fixedly mounted at lower ends of the support arms and a camera apparatus used to photographing is mounted between the two mounting bases by using a rotary shaft.

### CROSS-REFERENCE

This application is a continuation application of International Application No. PCT/CN2016/102899, filed on Oct. 21, 2016, which claims priority of Chinese Patent Application No. 201520931071.3, filed on Nov. 20, 2015, which is incorporated herein by reference in its entirety.

### BACKGROUND

### Technical Field

The present application relates to the field of gimbal and in particular, to a dual-arm gimbal.

### Related Art

A gimbal as a support device for mounting or fixing an appliance device such as a camcorder is mounted on a bearing member and is widely applied to fields such as shooting, photographing and monitoring. In the application field of unmanned aerial vehicle technologies, a gimbal is generally fixed on a vehicle body of an unmanned aerial vehicle which as a bearing member and a photographing device (such as a camera or a camcorder) used for aerial photography is carried by using the gimbal, so as to obtain a particular type of environmental information (such as a remote sensing image).

Generally, each gimbal in the existing market is in design of a mounted cantilever. The gimbal can satisfy 360° rotation, but because of a particular cantilever beam structure of the gimbal, deformation and rigidity loss occur in a transverse rolling shaft of the cantilever and consequently rigidity is insufficient at a bearing location. In addition, in a process of being transferred to a loading location, the deformation is increased and consequently a gap between shaft bearings at two ends of the cantilever is increased. As a result, a control precision and an execution speed are affected and a control difficulty is increased.

### SUMMARY

Therefore, a technical problem to be resolved by the present application is to overcome a technical defect of insufficient rigidity caused because a cantilever structure is adopted for a gimbal in the prior art, so as to provide a dual-arm gimbal with good rigidity.

To achieve the foregoing objective, the present application provides a dual-arm gimbal, including:

a support base, assembled on a gimbal base, where a first motor is assembled in the support base;

two support arms, assembled on the support base, where an upper end of each support arm is integrally connected to a first motor rotor of the first motor in the support base, so as to drive the support arm to rotate around the support base; and

two mounting bases, respectively fixedly mounted at lower ends of the support arms, where a camera apparatus used for photographing is mounted between the two mounting bases by using a rotary shaft.

Optionally, the support base is assembled on the gimbal base by using a support bracket, the support bracket is connected to the gimbal base in a movable manner and the support base is rotatable on the gimbal base.

Optionally, the two support arms are symmetrically disposed about an axis of the first motor rotor.

Optionally, an angle by which the support arm rotates around the support base is between ±40°.

Optionally, a second motor is mounted in at least one of the two mounting bases and a second motor rotor forms a rotary shaft and is integrally connected to a housing of the camera apparatus.

Optionally, the two mounting bases are disposed opposite to each other, second motors are respectively assembled in the mounting bases, motor shafts of the second motors are located in a same axial direction and second motor rotors are integrally connected to the housing of the camera apparatus, so as to drive the camera apparatus to pitch and deflect between the mounting bases.

Optionally, rotation speeds of the second motor rotors are the same and a rotation angle of the second motor rotor is capable of reaching 360°.

Optionally, the two mounting bases are disposed opposite to each other, a second motor is assembled in one of the mounting bases, the other mounting base is internally provided with a rotation hole coaxially relative to a motor shaft of the second motor; and the second motor rotor is integrally connected to the housing of the camera apparatus, an auxiliary rotary shaft is mounted on the camera apparatus and the auxiliary rotary shaft is inserted into the rotation hole and rotates in the rotation hole in a movable manner.

Optionally, a rotation angle of the second motor rotor is capable of reaching 360° and the auxiliary rotary shaft of the camera apparatus is rotatable by 360° in the rotation hole.

To achieve the foregoing objective, the present application further provides an aerial vehicle, including a vehicle main body and a gimbal connected to the vehicle main body, where the gimbal is the dual-arm gimbal according to any of the foregoing items.

The dual-arm gimbal and the aerial vehicle provided in the embodiments of the present application have the following advantages:

1. According to the dual-arm gimbal provided in the present application, the support arm rotates around the support base, the camera apparatus pitches and deflects in a movable manner between the two mounting bases by using the rotary shaft, the camera apparatus is supported by using the two support arms, so as to form a dual-arm support structure, so that neither the gap nor the deformation between the camera apparatus and the support arm is increased. Moreover, because a torque is a half of that of a cantilever, deformation transferred to the camera apparatus (that is, a loading location) is very small, so that the camera apparatus rigidly rotates between the two support arms and then effects of improving the rotation precision, the control precision and the gimbal stability are also achieved.

2. According to the dual-arm gimbal provided in the present application, the support base is assembled on the gimbal base in a movable manner by using a support bracket and the support base is rotatable on the gimbal base, so that the dual-arm gimbal is of a gimbal structure of three degrees of freedom, so as to improve flexibility of actions of the dual-arm gimbal, thereby achieving an effect of omnidirectional and multi-angle photographing.

3. According to the dual-arm gimbal provided in the present application, the two support arms are symmetrically disposed about the axis of the first motor rotor, so that the first motor rotor is uneasily deformed, so as to ensure stability of rotation of the two support arms.

4. According to the dual-arm gimbal provided in the present application, second motors located in a same axial direction are respectively assembled in the mounting bases and each second motor rotor is integrally connected to the housing of the camera apparatus, so as to ensure stability of pitching and deflection of the camera apparatus.

5. According to the dual-arm gimbal provided in the present application, a second motor is assembled in one of the mounting bases, the other mounting base is internally provided with a rotation hole, a second motor rotor is integrally connected to the housing of the camera apparatus and an auxiliary the rotary shaft inserted into the rotation hole is mounted on the camera apparatus. Because the rotation hole and a motor shaft of the second motor are coaxial, stability of pitching and deflection of the camera apparatus is ensured. Moreover, because a manner of integral connection at an end and movable insertion at the other end is adopted, the camera apparatus is assembled more simply and conveniently.

6. According to the aerial vehicle provided in the present application, because the aerial vehicle has the foregoing dual-arm gimbal, the aerial vehicle has an advantage according to any of the foregoing items.

### BRIEF DESCRIPTION OF THE DRAWINGS

To describe technical solutions of specific implementations of the present application more clearly, the present application is further described in detail below according to specific embodiments of the present application and with reference to accompanying drawings.

FIG. 1 is a three-dimensional diagram of an implementation of a dual-arm gimbal according to the present application;

FIG. 2 is a three-dimensional diagram of the dual-arm gimbal that is shown in FIG. 1 and from which a gimbal base and a support bracket are removed;

FIG. 3 is a longitudinal sectional view of the dual-arm gimbal that is shown in FIG. 2 and that is sectioned along

FIG. 4 is a schematic diagram of the dual-arm gimbal shown in FIG. 1 in which two arms rotate around a support base by an angle after the gimbal base is removed;

FIG. 5 is a schematic diagram of the dual-arm gimbal shown in FIG. 1 in which two arms rotate around the support base by another angle after the gimbal base is removed;

FIG. 6 is a schematic diagram of the dual-arm gimbal shown in FIG. 1 in which a camera apparatus deflects by an elevation angle after the gimbal base is removed; and

FIG. 7 is a schematic diagram of the dual-arm gimbal shown in FIG. 1 in which the camera apparatus deflects by a depression angle after the gimbal base is removed.

Tags in the accompanying drawings are described as follows:

10—support base; 20—gimbal base; 30—support arm; 41—first motor stator; 42—first motor rotor; 50—mounting base; 51—rotation hole; 60—camera apparatus; 61—auxiliary rotary shaft; 70—support bracket; 81—second motor rotor; and 82—second motor stator.

### DETAILED DESCRIPTION

The technical solutions according to the present application will be clearly and fully described in detail in the following with reference to the accompanying drawings. It is evident that the embodiments to be described are only a part of rather than all of the embodiments of the present application. All other embodiments obtained by a person of ordinary skill in the art based on the embodiments of the present application without creative efforts shall fall within the protection scope of the present application.

In the description of the present application, it should be noted that, a direction or location relationship indicated by a term “upper”, “lower”, or “inner” is a direction or location relationship based on the accompanying drawings, is only intended to conveniently describe the present application and simplified description, but is not intended to indicate or imply that a mentioned apparatus or element needs to have a particular direction and is constructed and operated in the particular direction and therefore cannot be understood as a limitation to the present application. Moreover, a term “first” or “second” is only used to describe an objective, but cannot be understood as indicating or implying a relative importance.

In the description of the present application, it should be noted that, unless otherwise explicitly specified and limited, a term “mounting” should be understood in a generalized sense, for example, may be dismountable mounting or fixed mounting. A person of ordinary skill in the art may understand specific meanings of the foregoing terms in the present application according to a specific situation.

Moreover, technical characteristics related to different implementations described below of the present application may be combined with each other, provided that the technical characteristics do not conflict with each other.

### Embodiment 1

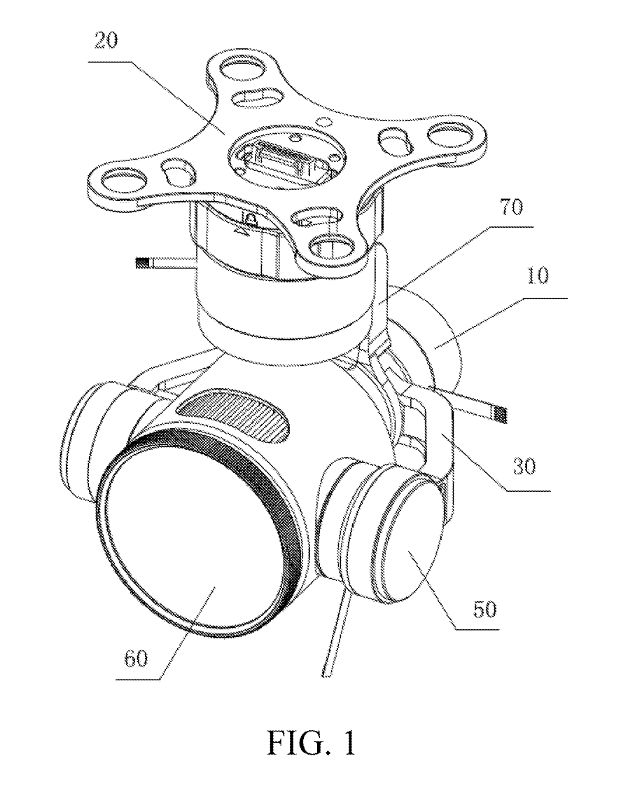

Referring to FIG. 1 to FIG. 3, a dual-arm gimbal provided in this embodiment is applicable to a bearing member such as an unmanned aerial vehicle gimbal on an unmanned aerial vehicle or a handheld gimbal and this is not limited. The dual-arm gimbal includes:

a support base 10, assembled on a gimbal base 20, where a first motor is assembled in the support base 10 and a first motor stator 41 of the first motor is fixed on the support base 10;

two support arms 30, assembled on the support base 10, where an upper end of each of the support arms 30 is integrally connected to a first motor rotor 42 of the first motor in the support base 10, so as to drive the support arm 30 to rotate around the support base 10; and

two mounting bases 50, respectively fixedly mounted at lower ends of the support arms 30, where a camera apparatus 60 used to photographing is mounted between the two mounting bases 50 by using a rotary shaft (not shown) and the camera apparatus 60 pitches and deflects in a movable manner between the two mounting bases 50.

The upper end and the lower end of the support arm 30 are respectively one end and the other end of the support arm 30, the upper end of the support arm 30 is one end close to the support base 10 and the lower end of the support arm 30 is one end away from the support base 10.

The dual-arm gimbal may be connected to an unmanned aerial vehicle or a handheld device by using the gimbal base 20. As an example instead of a limitation, the gimbal base 20 may be a shock absorption device or a buckling apparatus.

The support arm 30 of the dual-arm gimbal rotates around the support base 10, the camera apparatus 60 pitches and deflects in a movable manner between the two mounting bases 50 by using the rotary shaft, the camera apparatus 60 is supported by using the two support arms 30, so as to form a dual-arm support structure, so that neither the gap nor the deformation between the camera apparatus 60 and the support arm 30 is increased. Moreover, because a torque is a half of that of a cantilever, deformation transferred to the camera apparatus 60 (that is, a loading location) is very small, so that the camera apparatus 60 rigidly rotates between the two support arms 30 and then effects of improving the rotation precision, the control precision and the gimbal stability are also achieved.

As a preferred implementation, the first motor is a brushless direct drive motor. As a preferred implementation, as shown in FIG. 1, the support base 10 is assembled on the gimbal base 20 by using a support bracket 70, the support bracket 70 is connected to the gimbal base 20 in a movable manner and the support base 10 is rotatable on the gimbal base 20, so that the dual-arm gimbal is of a gimbal structure of three degrees of freedom, so as to improve flexibility of actions of the dual-arm gimbal, thereby achieving an effect of omnidirectional and multi-angle photographing.

As one of implementations, the dual-arm gimbal further includes a third motor. A stator of the third motor is fixedly connected to the gimbal base 20, a rotor of the third motor is fixedly connected to one end of the support bracket 70 and the other end of the support bracket 70 is fixedly connected to the support base 20. Specifically, the other end of the support bracket 70 may be fixedly connected to the stator of the first motor in the support base 20.

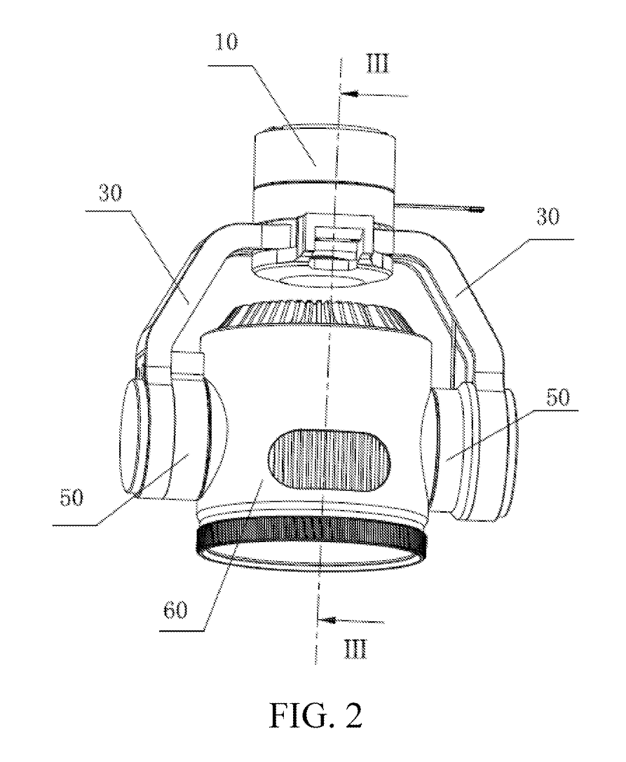

As a preferred implementation, as shown in FIG. 2, the two support arms 30 are symmetrically disposed about the axis of the first motor rotor 42, so that the first motor rotor 42 is uneasily deformed, so as to ensure stability of rotation of the two support arms 30.

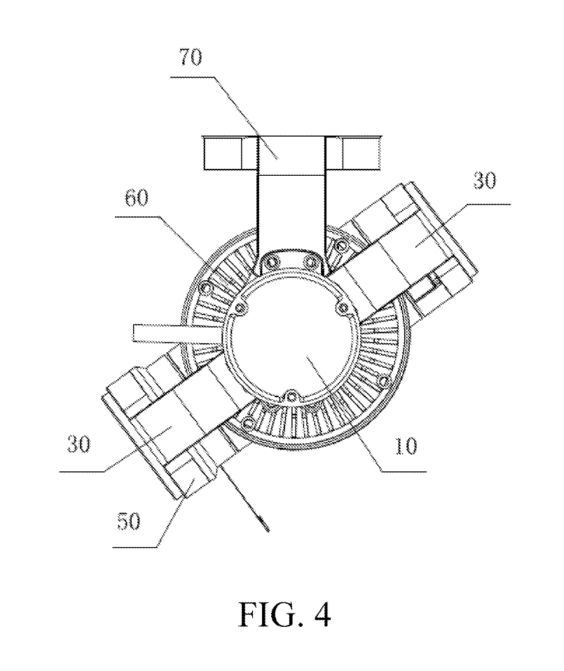

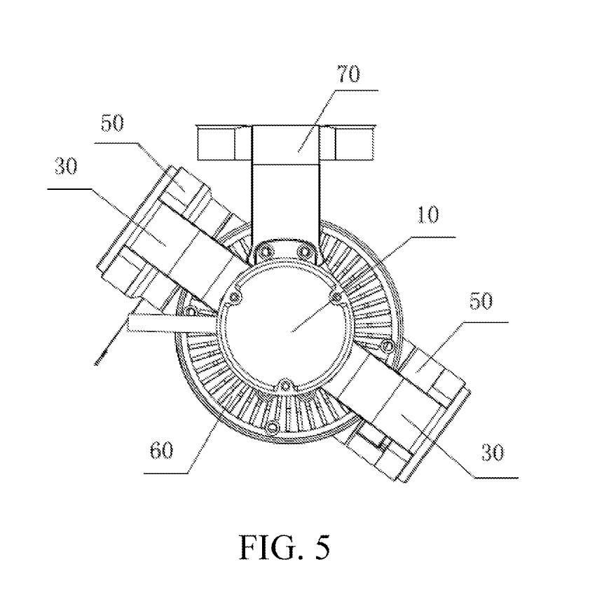

As a preferred implementation, an angle by which the support arm 30 rotates around the support base 10 is between ±40°. As shown in FIG. 4, an angle by which the support arm 30 rotates around the support base 10 is 36°. As shown in FIG. 5, an angle by which the support arm 30 rotates around the support base 10 is −36° and in addition, an angle by which the support arm 30 rotates around the support base 10 may further be between ±25° or ±30°.

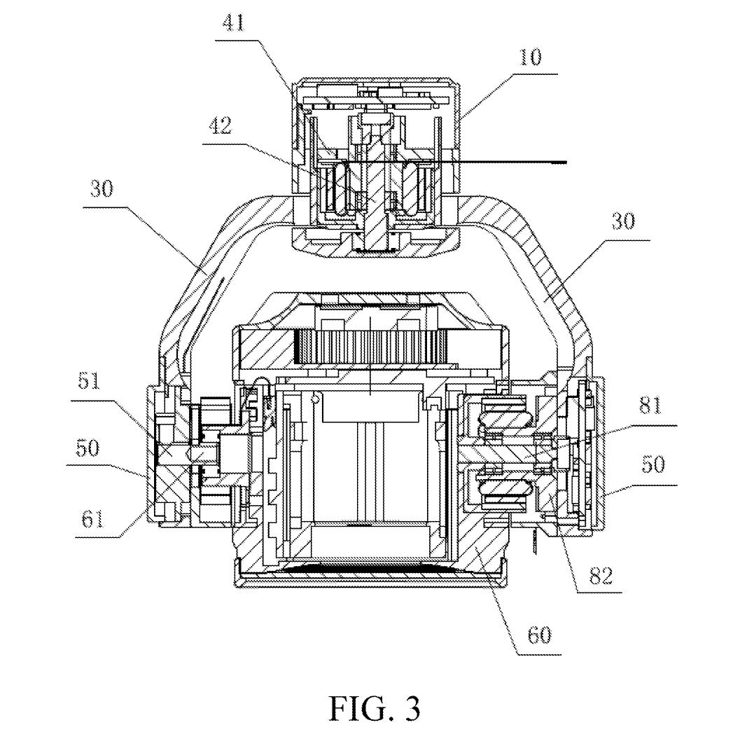

As shown in FIG. 2 and FIG. 3, a second motor is mounted in at least one of the two mounting bases 50 and the second motor rotor 81 forms the rotary shaft and is integrally connected to the housing of the camera apparatus 60. The so-called integral connection may be fixed connection between the second motor rotor 81 and the housing of the camera apparatus 60.

In a first implementation, the two mounting bases 50 are disposed opposite to each other, second motors are respectively assembled in the mounting bases 50, motor shafts of the second motors are located in a same axial direction, second motor rotors 81 are integrally connected to the housing of the camera apparatus 60 and second motor stators 82 are fixed in the mounting bases 50, so as to drive the camera apparatus 60 to pitch and deflect between the mounting bases 50. Because the second motors located in the same axial direction are respectively assembled in the mounting bases 50 and the second motor rotors 81 are integrally connected to the housing of the camera apparatus 60, so as to ensure stability of pitching and deflection of the camera apparatus 60.

As a preferred implementation, rotation speeds of the second motor rotors 81 are the same and a rotation angle of the second motor rotor 81 can reach 360°, that is, the camera apparatus 60 can deflect in a whole cycle.

In a second implementation, as shown in FIG. 3, the two mounting bases 50 are disposed opposite to each other, one of the second motors is assembled in one of the mounting bases 50 and the second motor rotor 81 is fixedly connected to the housing of the camera apparatus 60; and the other mounting base 50 is connected to the camera apparatus 60 in a movable manner by using an auxiliary rotary shaft 61. Specifically, the other mounting base 50 is internally provided with a rotation hole 51 coaxially relative to a motor shaft of the second motor, the auxiliary rotary shaft 61 is mounted on the camera apparatus 60 and the auxiliary rotary shaft 61 is inserted into the rotation hole 51 and rotates in the rotation hole 51 in a movable manner.

Because the rotation hole 51 and the motor shaft of the second motor are coaxial, stability of pitching and deflection of the camera apparatus 60 is ensured. Moreover, because a manner of integral connection at an end and movable insertion at the other end is adopted, the camera apparatus 60 is assembled more simply and conveniently.

As a preferred implementation, a rotation angle of the second motor rotor 81 can reach 360°, that is, the camera apparatus 60 can deflect in a whole cycle and moreover, the auxiliary rotary shaft 61 of the camera apparatus 60 may rotate by 360° in the rotation hole 51.

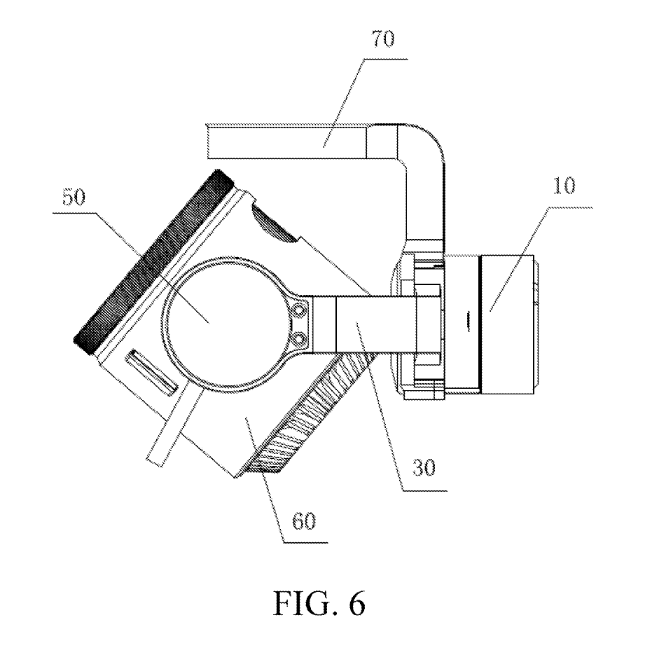

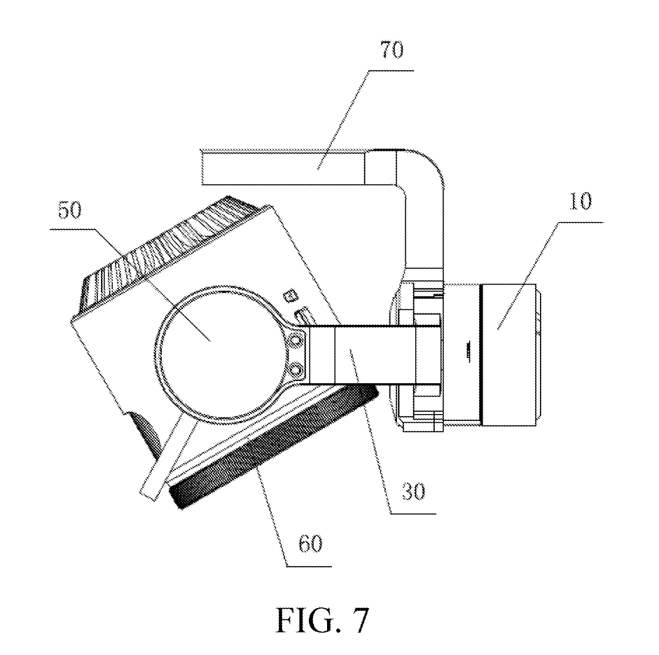

As a preferred implementation, as shown in FIG. 6, an elevation angle by which the camera apparatus 60 deflects is 50°. As shown in FIG. 7, a depression angle by which the camera apparatus 60 deflects is 120°. In addition, an elevation angle by which the camera apparatus 60 deflects may further be 30° , 40° , 60° and 70°; and a depression angle by which the camera apparatus 60 deflects may further be 60° , 70° , 80° , 90° , 100° and 110°.

### Embodiment 2

This embodiment provides an aerial vehicle (not shown), including a vehicle main body and a gimbal connected to the vehicle main body and the gimbal is any dual-arm gimbal recorded in Embodiment 1.

Any dual-arm gimbal recorded in Embodiment 1 is adopted for the aerial vehicle and therefore the aerial vehicle has any advantage of the dual-arm gimbal.

Obviously, the foregoing embodiments are only intended to clearly describe the examples that are made, but are not intended to limit the implementations. Based on the foregoing description, a person of ordinary skill in the art may further make other different forms of changes or variations. Herein, all implementations do not need to be and cannot be exhaustively listed. Obvious changes or variations derived from the present application still fall within the protection scope created by the present invention.

What is claimed is:

1. A dual-arm gimbal, comprising:
a support base, wherein a first motor is assembled in the support base;
two support arms, assembled on the support base, wherein one end of each of the support arms are integrally connected to a first motor rotor of the first motor; and
two mounting bases, respectively fixedly mounted at the other end of the support arms, wherein a camera apparatus used for photographing is mounted between the two mounting bases.

2. The dual-arm gimbal according to claim 1, further comprising a support bracket, wherein
the support base is assembled on a gimbal base by using the support bracket, the support bracket is connected to the gimbal base in a movable manner and the support base is rotatable on the gimbal base.

3. The dual-arm gimbal according to claim 2, further comprising a third motor, wherein
a stator of the third motor is fixedly connected to the gimbal base, a rotor of the third motor is fixedly connected to one end of the support bracket and the other end of the support bracket is fixedly connected to a stator of the first motor.

4. The dual-arm gimbal according to claim 1, wherein the two support arms are symmetrically disposed about an axis of the first motor rotor.

5. The dual-arm gimbal according to claim 1, wherein an angle by which the support arm rotates around the support base is between ±40°.

6. The dual-arm gimbal according to claim 1, wherein a second motor is mounted in at least one of the two mounting bases and a second motor rotor is integrally connected to a housing of the camera apparatus.

7. The dual-arm gimbal according to claim 6, wherein the two mounting bases are disposed opposite to each other, second motors are respectively assembled in the mounting bases, motor shafts of the second motors are located in a same axial direction and second motor rotors are integrally connected to the housing of the camera apparatus.

8. The dual-arm gimbal according to claim 7, wherein rotation speeds of the second motor rotors are the same.

9. The dual-arm gimbal according to claim 7, wherein a rotation angle of the second motor rotor is capable of reaching 360°.

10. The dual-arm gimbal according to claim 6, wherein the two mounting bases are disposed opposite to each other, one second motor is assembled in one of the mounting bases and a second motor rotor of the second motor is fixedly connected to the camera apparatus.

11. The dual-arm gimbal according to claim 10, wherein the other mounting base is connected to the camera apparatus in a movable manner by using an auxiliary rotary shaft.

12. The dual-arm gimbal according to claim 11, wherein the other mounting base is internally provided with a rotation hole coaxially relative to a motor shaft of the second motor; and the second motor rotor (81) is integrally connected to the housing of the camera apparatus, an auxiliary rotary shaft is mounted on the camera apparatus and the auxiliary rotary shaft is inserted into the rotation hole and rotates in the rotation hole in a movable manner.

13. The dual-arm gimbal according to claim 10, wherein a rotation angle of the second motor rotor is capable of reaching 360°.

14. The dual-arm gimbal according to claim 12, wherein the auxiliary rotary shaft of the camera apparatus is rotatable by 360° in the rotation hole.

15. An aerial vehicle, comprising a vehicle main body and a gimbal connected to the vehicle main body, wherein the gimbal is the dual-arm gimbal according to claim 1.
